(19) United States
(12) Patent Application Publication
(10) Pub. No.: US 2018/0013805 A1
(43) Pub. Date: Jan. 11, 2018

(54) HETEROGENEOUS MEDIA SERVICES

(71) Applicant: QUALCOMM Incorporated, San Diego, CA (US)

(72) Inventors: Giridhar Mandyam, San Diego, CA (US); Charles Nung Lo, San Diego, CA (US); Gordon Kent Walker, Poway, CA (US); Thomas Stockhammer, Bergen (DE); Nagaraju Naik, San Diego, CA (US); Carlos Marcelo Dias Pazos, Carlsbad, CA (US)

(21) Appl. No.: 15/601,500

(22) Filed: May 22, 2017

Related U.S. Application Data
(60) Provisional application No. 62/360,708, filed on Jul. 11, 2016.

(51) Int. Cl. H04L 29/06; H04N 21/482; H04N 21/234; H04N 21/845

(52) U.S. Cl. CPC H04L 65/4076; H04N 21/8456; H04N 21/4828; H04L 63/10; H04L 65/60; H04N 21/234

(57) ABSTRACT

Systems and methods adapted for providing heterogeneous media services in communication systems, such as using transport layer security deferral and/or medium redirect, are disclosed. In operation according to embodiments, heterogeneous media services may be facilitated by obtaining, by a hybrid broadcast receiver of a receiver device, a computer parsable object comprising information regarding content segment availability and access, wherein the hybrid broadcast receiver is adapted to obtain content via both broadcast and broadband connections for a streaming client of the receiver device. The hybrid broadcast receiver of embodiments may further operate to evaluate the computer parsable object for one or more content segment entries indicating transport layer security is to be invoked with respect to a connection used for obtaining one or more content segments and to overwrite the one or more content segment entries preventing the transport layer security from being invoked by the streaming client.

### CROSS-REFERENCE TO RELATED APPLICATIONS

This application claims the benefit of U.S. Provisional Patent Application No. 62/360,708, entitled, “HETEROGENEOUS MEDIA SERVICES SUPPORT USING TRANSPORT LAYER SECURITY DEFERRAL AND/OR MEDIUM REDIRECT,” filed on Jul. 11, 2016, the disclosure of which is hereby incorporated by reference herein in its entirety as if fully set forth below and for all applicable purposes.

### BACKGROUND

### Field

Aspects of the present disclosure relate generally to communication systems, and more particularly, aspects relate to providing for heterogeneous media services in communication systems using transport layer security deferral and/or medium redirect techniques.

### Background

Digital multimedia (including audio and video and other media) capabilities can be incorporated into a wide range of devices. For example, various devices, such as digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like, may be utilized as receiver devices operable to request, receive, and/or play digital multimedia content. Such receiver devices may be in communication with one or more content servers for obtaining digital multimedia content via one or more communication networks.

A number of configurations of communication networks, including wireless and wireline communication networks, suitable for delivery of digital multimedia content are widely deployed to provide various communication services such as voice, video, packet data, messaging, broadcast, and the like. Examples of communication networks suitable for providing broadband delivery of digital multimedia content (e.g., using either unicast or multicast transmission) include the Universal Terrestrial Radio Access Network (UTRAN), the Internet, a local area network (LAN), a wireless LAN (WLAN), a metropolitan area network (MAN), and a wide area network (WAN). Examples of communication networks suitable for providing broadcast delivery of digital multimedia content include over-the-air (OTA) broadcast systems such as Advanced Television Systems Committee (ATSC), Digital Video Broadcasting-Terrestrial (DVB-T), and Long Term Evolution Evolved Multimedia Broadcast Multicast Services (LTE eMBMS). It should be appreciated that in the aforementioned broadcast delivery of digital multimedia content there need not be any previous election to join or negotiated reception credentials by the receiver device, in contrast to unicast or multicast where, for example, clients receive a stream of packets only if they have previously elected to do so (e.g., by performing security handshaking, joining the specific multicast group address, etc.).

Hypertext Transfer Protocol (HTTP) streaming is currently a popular method of delivering digital multimedia content over communication networks. For live events, content is made available progressively through constant duration segments. The segment availability follows a timeline that indicates when each successive segment becomes available at the HTTP server.

Dynamic Adaptive Streaming Over Hypertext Transfer Protocol (DASH) is a standard that implements HTTP streaming. A receiver may, for example, utilize a DASH client configuration for delivery of digital multimedia content from a content server. In operation, DASH announces the segment availability in a Media Presentation Description (MPD), wherein the MPD is a segment availability timeline that provides information regarding the segments, the times segments are available, and the size of the segments.

DASH services have been standardized for OTA broadcast systems, such as the aforementioned ATSC, DVB-T, and LTE eMBMS systems. However, the design of such systems does not address transport layer security (TLS) compatibility. In particular, encryption that is negotiated between the two endpoints (e.g., the DASH client at the receiver device and the content server) as part of a TLS handshake is not compatible with the one-to-many broadcast nature of the digital multimedia content DASH transmission.

Many media endpoint applications, such as off-the-shelf web runtime engines operable on the receiver devices prevent delivery of at least some content without TLS support. For example, web browsers such as CHROME, available from Google Inc., and FIREFOX, available from Mozilla Corporation, operate to prevent streaming of content protected by digital rights management (DRM) without TLS support in light of the exchange of personal information associated with DRM protocols implemented between the client and server. Accordingly, prior solutions have utilized a configuration in which DASH segments received via a broadcast transmission are deposited into a local (i.e., on-device) server that is accessible by the DASH client (e.g., HTTP://LOCALHOST accessed by the browser implementing a DASH client). Such configurations have been considered a secure context so that DRM is not an issue.

The aforementioned local server solutions, however, present challenges with respect to heterogeneous content delivery, where content is made available both via broadband delivery (e.g., content servers in communication using one or more UTRAN, the Internet, a LAN, a WLAN, a MAN, a WAN, etc. communication networks) and via broadcast delivery (e.g., content transmitters in communication using one or more ATSC, DVB-T, LTE eMBMS, etc. broadcast systems). For example, heterogeneous delivery complicates DASH client use of MPD data where digital multimedia segments available via broadcast would be referenced at a broadcast receiver implementing a local server (e.g., MPD data pointing to HTTP://LOCALHOST), while digital multimedia segments available via broadband would be directly referenced in the MPD (e.g. MPD data pointing to HTTPS://SOMEURL.SOMEWHERE). Applicants of the present application have observed that, if digital multimedia segment retrieval is triggered by the DASH client using TLS, as may be required by the runtime engine, then the broadcast receiver cannot intermediate if DASH client requests are HTTPS due to the secure communication provided by the TLS (e.g., the broadcast receiver cannot peek into and/or analyze actual segment requests given the requests will be encrypted). Accordingly, Applicants of the present application have observed that, even if a digital multimedia segment is available via broadcast, the broadcast receiver cannot prevent broadband retrieval of the content by the DASH client, in absence of blocking all broadband requests from device. However, the DASH client typically does not have insight into broadcast availability, particularly if running in a browser, and thus may not operate to intelligently issue digital multimedia segment requests with respect to heterogeneous content delivery availability.

Modification of the DASH client become “broadcast aware” to accommodate heterogeneous content delivery availability may be undesirable for a number of reasons. For example, it would be quite complicated to modify a DASH client, particularly where the DASH client is implemented in a browser, to know when content is available via broadcast or broadband and to implement logic for determining when to make an HTTPS digital multimedia segment request (broadband request) or when to fetch the digital multimedia segment from a local server (provided by broadcast delivery). In a configuration in which the DASH client is implemented in a browser, broadcast awareness modification of the DASH client would necessitate working with the browser provider (e.g., Google, Mozilla, etc.) and would likely provide a solution unique to the particular host system chip set upon which the system is executed, thus providing a solution that may not receive sufficiently widespread adoption and use.

### SUMMARY

In one aspect of the disclosure, a method for facilitating heterogeneous media services in a communication system is provided. The method of embodiments includes obtaining, by a hybrid broadcast receiver of a receiver device, a computer parsable object comprising information regarding content segment availability and access, wherein the hybrid broadcast receiver comprises a receiver adapted to obtain content via both broadcast and broadband connections for a streaming client of the receiver device. Embodiments of the method further includes evaluating, by the hybrid broadcast receiver, the computer parsable object for one or more content segment entries indicating transport layer security is to be invoked with respect to a connection used for obtaining one or more content segments, and overwriting, by the hybrid broadcast receiver, the one or more content segment entries preventing the transport layer security from being invoked by the streaming client.

In an additional aspect of the disclosure, an apparatus configured for facilitating heterogeneous media services in a communication system is provided. The apparatus of embodiments includes means for obtaining, by a hybrid broadcast receiver of a receiver device, a computer parsable object comprising information regarding content segment availability and access, wherein the hybrid broadcast receiver comprises a receiver adapted to obtain content via both broadcast and broadband connections for a streaming client of the receiver device. Embodiments of the apparatus further include means for evaluating, by the hybrid broadcast receiver, the computer parsable object for one or more content segment entries indicating transport layer security is to be invoked with respect to a connection used for obtaining one or more content segments, and means for overwriting, by the hybrid broadcast receiver, the one or more content segment entries preventing the transport layer security from being invoked by the streaming client.

In an additional aspect of the disclosure, a non-transitory computer-readable medium having program code recorded thereon is provided. The program code of embodiments includes code for causing a hybrid broadcast receiver of a receiver device to obtain a computer parsable object comprising information regarding content segment availability and access, wherein the hybrid broadcast receiver comprises a receiver adapted to obtain content via both broadcast and broadband connections for a streaming client of the receiver device. Embodiments of the program code further includes code for causing the hybrid broadcast receiver to evaluate the computer parsable object for one or more content segment entries indicating transport layer security is to be invoked with respect to a connection used for obtaining one or more content segments, and code for causing the hybrid broadcast receiver to overwrite the one or more content segment entries preventing the transport layer security from being invoked by the streaming client.

In an additional aspect of the disclosure, an apparatus configured for facilitating heterogeneous media services in a communication system is provided. The apparatus of embodiments includes at least one processor, and a memory coupled to the processor. Embodiments of the processor is configured to obtain, by a hybrid broadcast receiver of a receiver device, a computer parsable object comprising information regarding content segment availability and access, wherein the hybrid broadcast receiver comprises a receiver adapted to obtain content via both broadcast and broadband connections for a streaming client of the receiver device. The processor of embodiments is further configured to evaluate, by the hybrid broadcast receiver, the computer parsable object for one or more content segment entries indicating transport layer security is to be invoked with respect to a connection used for obtaining one or more content segments, and to overwrite, by the hybrid broadcast receiver, the one or more content segment entries preventing the transport layer security from being invoked by the streaming client.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a communication system including a receiver device adapted according to embodiments of the present disclosure.

FIG. 2 is a high level flow diagram of operation of a receiver device implementing a hybrid broadcast receiver embodiment of the present disclosure.

FIGS. 3 and 4 are diagrams illustrating receiver device configurations adapted to implement hybrid broadcast receiver embodiments of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The word “exemplary” is used herein to mean “serving as an example, instance, or illustration.” Any aspect described herein as “exemplary” is not necessarily to be construed as preferred or advantageous over other aspects.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

As used in this description, the term “content” may include data having video, audio, combinations of video and audio (e.g., digital multimedia content), or other data at one or more quality levels, the quality level determined by bit rate, resolution, or other factors. The content may also include executable content, such as: object code, scripts, byte code, markup language files, and patches. In addition, “content” may also include files that are not executable in nature, such as documents that may need to be opened or other data files that need to be accessed.

As used in the description herein, the term “receiving station” refers to a wireline and/or wireless communication system at least configured to receive signals (e.g., radio frequency (RF) signals), such as may carry various content to be utilized by one or more devices of or coupled to the receiving station. A receiving station of embodiments may additionally provide for transmission of signals, and thus a receiving station of embodiments may comprise a transceiver station. A receiving station herein may, for example, comprise one or more digital televisions, set top boxes, Digital Video Recorder (DVR), digital direct broadcast systems, wireless broadcast systems, PDAs, laptop or desktop computers, digital cameras, digital recording devices, digital media players, video gaming devices, video game consoles, cellular or satellite radio telephones, video teleconferencing devices, and/or the like.

As used in this description, the term “segment” refers to portion of content, such as may comprise one of a plurality of constant duration segments that in the aggregate comprise the content, as may be made available progressively as part of streaming content. Segment availability may follow a timeline corresponding to when each successive segment falls within the overall content.

As used in this description, the term “streaming content” refers to content that may be sent (e.g., in segments) from a source server device, such as a server, head-end system, etc., and received at a receiving device, such as a user device, terminal equipment, etc., according to one or more standards that enable the transfer of content, whether in real-time or otherwise. Examples of streaming content standards include those that support de-interleaved (or multiple) channels and those that do not support de-interleaved (or multiple) channels.

As used herein, the terms “user equipment,” “user device,” and “client device” include devices capable of receiving content, such as from a server or other source, and may comprise a receiving station, or portion thereof, herein. Such devices can be stationary devices or mobile devices. The terms “user equipment,” “user device,” and “client device” can be used interchangeably.

As used herein, the term “user” refers to an individual using, accessing, or otherwise associated with the operation of a user device. For example, a user may receive content via a user device or a client device.

Systems and methods disclosed herein provide for delivery of content via broadband and/or broadcast transmission. For example, where content is made available both via broadband delivery and via broadcast delivery, embodiments facilitate heterogeneous content delivery using a DASH client configuration which is not “broadcast aware”. Embodiments comprise a hybrid broadcast receiver configuration operable to arbitrate when segments are downloaded either via broadcast or broadband. In operation of a hybrid broadcast receiver configuration of embodiments, broadcast delivery of segments are leveraged as appropriate without inhibiting the availability of broadband delivery of segments to a DASH client.

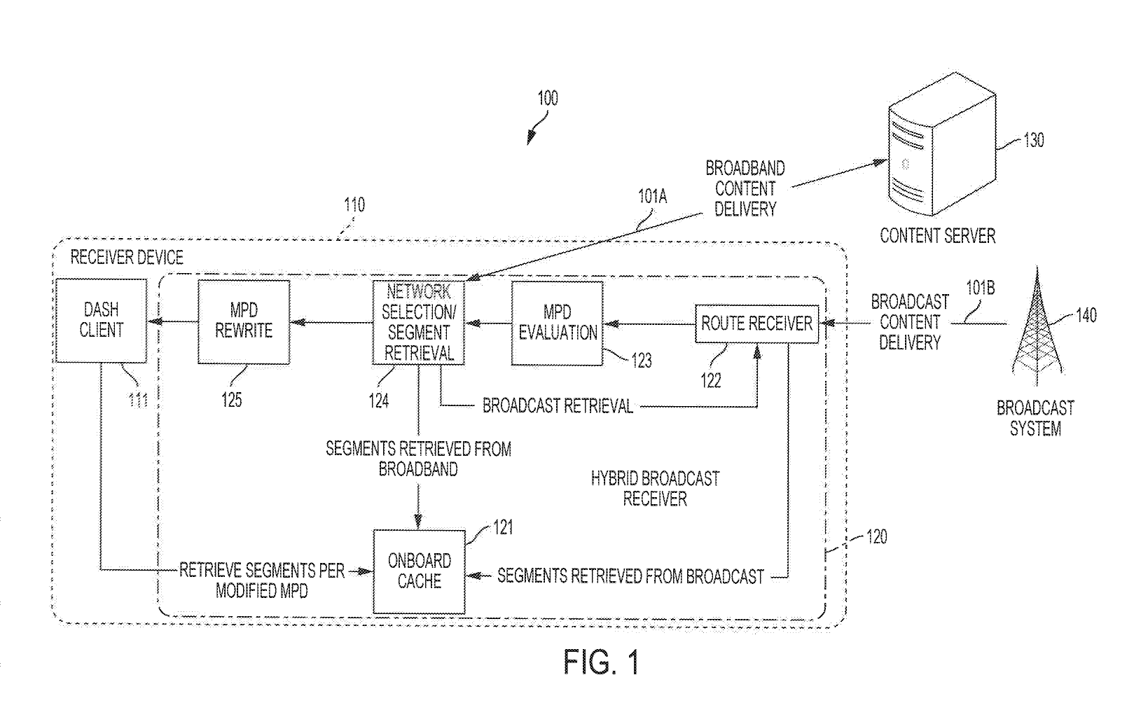

FIG. 1 illustrates communication system 100 adapted for providing heterogeneous media services in communication systems, such as using transport layer security deferral and/or medium redirect, according to various embodiments. Communication system 100 illustrated in FIG. 1 includes multiple devices, such as receiver device 110, content server 130, and broadcast system 140, providing for delivery of content via broadband delivery techniques and broadcast delivery techniques. Accordingly, receiver device 110 of the exemplary embodiment is adapted to exchange data via one or more connections 101. For example, receiver device 110 may exchange data with content server 130 via connection 101A providing a broadband link (e.g., a wireline and/or wireless data communication link provided by one or more UTRAN, the Internet, a LAN, a WLAN, a MAN, a WAN, etc. communication networks). Additionally or alternatively, receiver device 110 may exchange data with broadcast system 140 via connection 101B providing a broadcast link (e.g., a wireline and/or wireless data communication link provided by one or more ATSC, DVB-T, LTE eMBMS, etc. broadcast systems).

Content server 130 of embodiments may, for example, comprise a content provider server or encoder providing Media Presentation Description (MPDs) and segments for output via a DASH client (e.g., DASH client 111 of receiver device 110). Broadcast system 140 of embodiments may, for example, comprise a Broadcast Multimedia Service Center (BMSC) server which may receive MPDs and segments output from the encoder and control the over-the-air (OTA) broadcast transmission of the MPDs and segments. It should be appreciated that, while operation in accordance with embodiments may be described with reference to OTA transmissions, features herein may be used in connection with wired transmissions, wireless transmissions, or a combination of wired and wireless transmissions. Thus, OTA transmission is not required.

Receiver device 110 illustrated in FIG. 1 includes DASH client 111 (e.g., an instance of a generally available DASH client, as is known in the art) operable to request, receive, and/or play content provided as a plurality of segments from one or more sources, such as content server 130 and/or broadcast system 140. Although DASH client 111 of embodiments may not be “broadcast aware” (i.e., not configured to know when content is available via broadcast or broadband and to implement logic for determining when to make a broadband segment request or when to obtain the segment via broadcast delivery), DASH client 111 may nevertheless be enabled to utilize heterogeneous media services through operation of hybrid broadcast receiver 120 of receiver device 110. For example, logic of hybrid broadcast receiver 120 is operable to analyze information regarding content requested by DASH client 111, to determine when content is available via broadcast (e.g., available via connection 101B providing a broadcast connection between receiver device 110 and broadcast system 140) and/or broadband (e.g., available via connection 101A providing a broadband connection between receiver device 110 and content server 130), and to determine when broadband or broadcast delivery is to be used with respect to the content delivery. Such determinations may be made with respect to a particular content object (e.g., multimedia program, file, etc.) or may be made at a more granular level (e.g., on a segment by segment basis, within a particular content object).

Accordingly, hybrid broadcast receiver 120 is shown including a plurality of functional blocks cooperating to perform operations as described herein. In particular, hybrid broadcast receiver 120 of the embodiment illustrated in FIG. 1 includes cache 121 (e.g., a local host cache for storing content segments to be provided to DASH client 111), receiver 122 (e.g., a receiver operable in accordance with the ATSC Real-time Object delivery over Unidirectional Transport (ROUTE) protocol to fetch segments via broadcast delivery and deposit segments into a local cache, such as cache 121), MPD evaluation logic 123 (e.g., processor-based logic adapted to analyze MPD information for broadband and broadcast segment availability), network selection and segment retrieval logic 124 (e.g., processor-based logic adapted to make decisions as to a medium to retrieve segments over and to control fetching of segments in accordance with the decisions), and MPD rewrite logic 125 (e.g., processor-based logic adapted to alter MPD entries in accordance with determinations made by network selection and segment retrieval logic 124). The functional blocks and modules in hybrid broadcast receiver 120 of FIG. 1 may comprise processors, electronics devices, hardware devices, electronics components, logical circuits, memories, software codes, firmware codes, etc., or any combination thereof.

Hybrid broadcast receiver 120 of embodiments operates to intercept the MPD for particular content to be delivered to DASH client 111 and alters the MPD to facilitate control by hybrid broadcast receiver 120 of segment requests made by DASH client 111. For example, the MPD may comprise a plain text (e.g., XML) or other computer parsable file or other object comprising information regarding content segment availability and access. In order to facilitate visibility into segment requests made by the DASH client, all instances of Uniform Resource Locators (URLs) implementing transport layer security may be rewritten as URLs without transport layer security (e.g., Hypertext Transfer Protocol Secure (HTTPS) entries, HTTPS://, are rewritten as HTTP entries without the transport layer security attribute, HTTP://), whereby the requests made by the DASH client may be intercepted by the hybrid broadcast receiver and the segments fetched (e.g., via broadcast or broadband) in accordance with logic of the hybrid broadcast receiver. Additionally or alternatively, hybrid broadcast receiver 120 may operate to analyze the MPD and overwrite all instances of the Uniform Resource Locators (URLs) therein to point to a local host of the hybrid broadcast receiver (e.g., HTTPS://SOMEURL.SOMEWHERE rewritten as HTTP://LOCALHOST), whereby all segments, whether fetched via broadband (e.g., using connection 101A) or broadcast (e.g., using connection 101B) are deposited in a local host cache (e.g., cache 121) for delivery to DASH client 111. Hybrid broadcast receiver 120 of embodiments thus may operate to intermediate all segment requests made by DASH client 111, wherein intermediation by the hybrid broadcast receiver may fetch segments via broadband and/or broadcast as determined appropriate (e.g., based upon availability via broadcast and/or broadcast, a source/link meeting quality of service (QoS) metrics, user preferences regarding broadband and/or broadcast connectivity, etc.).

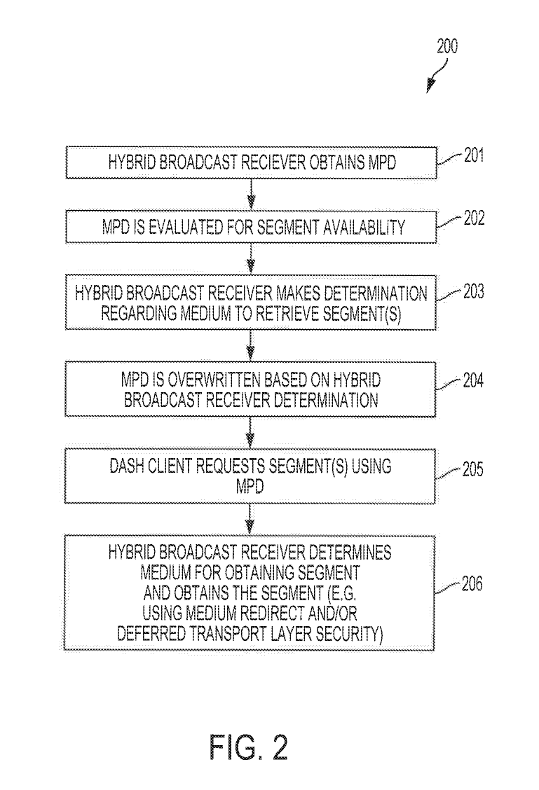

FIG. 2 shows flow 200 for implementing heterogeneous media services in accordance with embodiments of the disclosure. It should be appreciated that the various processes of flow 200 may be performed by receiver device 110, such as by operation of appropriate ones of the aforementioned functional blocks therein, in accordance with the concepts herein.

At block 201 of the embodiment of flow 200 illustrated in FIG. 2, hybrid broadcast receiver 120 obtains an MPD for particular content to be provided to DASH client 111. For example, receiver 122 of hybrid broadcast receiver 120 may receive the MPD through OTA broadcast transmission via connection 101B. The MPD includes information on segment availability for the content to be provided to DASH client 111. In operation according to embodiments, the MPD may contain information on broadband availability of segments, information on broadcast availability of segments, or information on both broadband and broadcast availability of segments (e.g., each being indicated through URL addressing of segments).

Information regarding the availability of segments provided by the MPD is evaluated by logic (e.g., MPD evaluation logic 123) of hybrid broadcast receiver 120 of embodiments for determining the delivery path (e.g., connection 101A or connection 101B) for one or more segments at block 202. Embodiments may evaluate other information, in addition to the segment availability information provided in the MPD, for the determination of delivery path with respect to segment(s). For example, analysis of broadcast signaling such as User Service Bundle Description (USBD) may be utilized assist in the delivery path determination (e.g., by explicit mapping of MPD BaseURL patterns to broadcast or broadband delivery).

At block 203, hybrid broadcast receiver 120 of embodiments operates to make a determination as to the medium or media to retrieve one or more segments based on the information evaluation provided in block 202. For example, network selection and segment retrieval logic 124 may determine that a particular medium is available or unavailable, that a particular medium or source associated with a medium is providing poor transmission or not meeting a QoS level, that a particular medium does or does not meet one or more user connectivity preferences, etc. and make determinations regarding the medium or media to retrieve one or more segments accordingly.

Hybrid broadcast receiver 120 may operate at block 204 to overwrite or otherwise modify the MPD, or some portion thereof, to facilitate control of segment requests made by DASH client 111 based upon the foregoing determinations regarding the medium or media to retrieve segments. In operation according to embodiments, hybrid broadcast receiver 120 inspects the MPD, inspects the availability of the content over broadband, inspects the availability of the content over broadcast, and may modify the MPD so as to eliminate options for the DASH client based upon one or more determinations made in light of such inspection. For example, MPD rewrite logic 125 of hybrid broadcast receiver 120 may operate to eliminate entries in the MPD for broadband retrieval of segments when only broadcast delivery is available or desirable (e.g., meets user connectivity preferences). Similarly, MPD rewrite logic 125 may operate to eliminate entries in the MPD for one or more broadband URLs when the hybrid broadcast receiver has already retrieved and cached the segment (either from broadcast or broadband). As a further example, MPD rewrite logic 125 may operate to eliminate entries in the MPD for broadcast delivery when receiver 122 is encountering poor reception conditions (temporarily or permanently), and broadband delivery is available.

In operation at block 204 according to embodiments, MPD rewrite logic 125 additionally or alternatively overwrites or otherwise modifies MPD entries implementing transport layer security to provide entries such that DASH client 111 making a segment request based upon the MPD entry does not employ transport layer security (e.g., HTTPS://rewritten as HTTP://) to prevent the DASH client from originating a secure connection (e.g., in order to facilitate intercepting the request by hybrid broadcast receiver 120, whereby transport layer security may nevertheless be invoked by the hybrid broadcast receiver when requesting the segment, such as over broadband connection 101A). By overwriting or otherwise modifying MPD entries to prevent the DASH client from implementing transport layer security with respect to the segment requests, and instead implementing the transport layer security for corresponding segment requests made by the hybrid broadcast receiver (i.e., implementing deferred transport layer security) heterogeneous media services may be provided with transport layer security support in accordance with embodiments of the disclosure. Thus, as shown above, MPD rewrite logic 125 may overwrite one or more content segment entries of a computer parsable object, such as MPD entries of an MPD, thus preventing transport layer security from being invoked by a streaming client, such as DASH client 111. In embodiments in which MPD rewrite logic 125 overwrites one or more content segment entries preventing transport layer security from being invoked by a streaming client, MPD rewrite logic 125 may perform such overwriting in response to hybrid broadcast receiver 120: (1) evaluating a computer parsable object, such as an MPD, for any content segment entries indicating transport layer security is to be invoked and (2) determining that one or more of the content segment entries indicate that transport layer security is to be invoked. This overwriting may include, for example, deleting an entry and replacing the deleted entry with a modified version of the deleted entry; modifying a portion of an entry; other overwriting acts; or any combination thereof.

It can be appreciated from the foregoing that hybrid broadcast receiver 120 of embodiments can leverage the above described MPD rewrite technique (e.g., new URLs written in the MPD) to intercept and initiate redirect of segment requests by DASH client 111. In operation according to embodiments, hybrid broadcast receiver 120 may, for example, act as proxy for HTTP:// requests instead of HTTPS:// requests. Additionally or alternatively, MPD rewrites (e.g., changing the base URLs in the MPD) by hybrid broadcast receiver 120 may be done to point the DASH client to a cache (e.g., cache 121) maintained by the hybrid broadcast receiver. For example, hybrid broadcast receiver 120 may rewrite URLs in the MPD that directly reference segments available via broadband (e.g. HTTPS://SOMEURL.SOMEWHERE) to point to a cache (e.g., HTTP://LOCALHOST, HTTP://LOCALHOST.BC, or HTTP://LOCALHOST.UC). The use of the exemplary “.BC” and “.UC” designators in the foregoing URLs may, for example, be advantageous to a DASH client that implements some level of insight into the type of access over which a segment was retrieved. For instance, if the application observes only broadcast retrieval of segments over a certain period of time, it may infer that broadband retrieval of non-DASH content is not possible and as a result may not even originate such requests.

At block 205 of the illustrated embodiment of flow 200, DASH client 111 uses the overwritten MPD to request one or more segments. For example, DASH client 111 may reference the overwritten MPD to determine a next segment in a streaming content session and request that segment in accordance with the information provided in the overwritten MPD. Where the pointer to the segment has been overwritten by hybrid broadcast receiver 120 (e.g., to prevent utilization of transport layer security by the DASH client), DASH client 111 may, for example, be manipulated to make a segment request that is intercepted by the hybrid broadcast receiver. Hybrid broadcast receiver 120 may thus determine the medium for fetching the segment (e.g., using broadband connection 101A or broadcast connection 101B) and make the request using the determined medium at block 206. For example, the hybrid broadcast receiver may determine that a segment for which the request made by the DASH client is for broadband delivery is instead to be obtained via broadcast delivery, thereby implementing medium redirect. Where the overwriting of the pointer to the segment includes rewriting of the URL, for example, DASH client 111 may be manipulated to obtain the segment from cache 121 of the hybrid broadcast receiver to accommodate medium redirect by the hybrid broadcast receiver. In the case that hybrid broadcast receiver 120 determines that the segment for which the request made by the DASH client is to be obtained via broadband delivery, the hybrid broadcast receiver may utilize transport layer security with respect to the broadband request, despite the request having been made by the DASH client without transport layer security (i.e., using an overwritten MPD entry), thereby implementing deferred transport layer security.

As a specific example of the use of the foregoing overwritten MPD, assume a situation in which DASH client 111 is playing streaming content having one or more optional tracks (e.g., optional audio tracks, optional camera angle video tracks, etc.) associated therewith that are available via broadband and broadcast. Such optional tracks are generally not retrieved and cached by a receiver unless and until requested by the client. Nevertheless, hybrid broadcast receiver 120 of embodiments may overwrite the pointers in the MPD to such optional tracks to eliminate entries in the MPD for their broadband URLs (e.g., to prevent DASH client 111 from directly requesting segments of the optional tracks), to provide URLs without transport layer security (e.g., HTTPS:// rewritten as HTTP://, to facilitate intercepting the optional track segment requests by hybrid broadcast receiver 120), etc. Thus, hybrid broadcast receiver 120 may operate to download the optional content via broadcast.

It should be appreciated from the foregoing that a hybrid broadcast receiver of embodiments operates to overwrite MPD data with respect to not only content that the hybrid broadcast receiver is caching, but additionally or alternatively MPD data for content that is not then being cached by (and may never be fetched or cached by) the hybrid broadcast receiver. Accordingly, when the DASH client requests content other than that being cached by the hybrid broadcast receiver (e.g., the aforementioned optional tracks), the requests may nevertheless be intercepted by the hybrid broadcast receiver and the operation of the DASH client may be controlled. Moreover, although transport layer security may be prevented with respect to the segment requests made by the DASH client (e.g., by HTTPS:// rewritten as HTTP:// to facilitate intercepting requests by the hybrid broadcast receiver), transport layer security may nevertheless be implemented, and the requisite transport layer security requirements met (e.g., the requests for which transport layer security is prevented are internal to the receiver device), such as by the hybrid broadcast receiver issuing its own requests to the content server using transport layer security (e.g., HTTPS:// requests) or by the hybrid broadcast receiver providing a local server implementation with respect to broadcast content.

A hybrid broadcast receiver of embodiments of the disclosure has access to system information that the DASH client may not have, particularly in situations where the DASH client is implemented in browser or similar host environment. For example, a hybrid broadcast receiver may have access to information such as user accessibility and content (e.g., parental control) preferences, availability of data service via broadband, and/or availability of segments via broadcast and broadband. Operation of a hybrid broadcast receiver to overwrite MPD information allows for the DASH client to operate without having access to sensitive user information.

In general, a DASH client is not typically configured to make proper network selection decisions for retrieval of content under heterogenous delivery scenarios. For example, a DASH client typically does not know the availability of segments via broadcast. Additionally, a DASH client typically cannot determine the data delivery metrics utilized for system selection in an accurate manner. In particular, a DASH client typically cannot determine a delivery system that meets QoS requirements (e.g., minimization of latency, balancing throughput requirements and cellular data charges, etc.).

A hybrid broadcast receiver of embodiments herein performs intelligent mediation of all content requests from a DASH client, while fulfilling secure origin requirements. In operation, a hybrid broadcast receiver may leverage availability of broadband connections (e.g., 3G/4G data services or WiFi) as well as take advantage of low cost/zero cost data delivery charge over broadcast connections, as appropriate or desired.

It should be appreciated that, although embodiments of hybrid broadcast receivers have been described with reference to DASH clients, the concepts herein are not limited to application with respect to DASH clients. A hybrid broadcast receiver of embodiments may facilitate heterogeneous media services with respect to a number of different streaming client configurations, including streaming clients that do not operate in accordance with DASH protocols. For example, a hybrid broadcast receiver operable in accordance with embodiments herein may facilitate heterogeneous media services with respect to a client utilizing Moving Picture Experts Group (MPEG) Multimedia Transport (MMT, ref. ISO/IEC DIS 23008), in which associated segments may be retrieved over broadcast or broadband. Moreover in some deployments, media segments encoded as MMT may be retrieved over broadcast, while the corresponding segments may be DASH encoded when delivered via broadband.

Further, it should be appreciated that, although embodiments of hybrid broadcast receivers have been described with reference to overwriting MPDs, the concepts herein are not limited to application with respect to such MPDs. A hybrid broadcast receiver of embodiments may facilitate heterogeneous media services through implementing overwriting of various other computer parsable files or other objects comprising information regarding content segment availability and access. For example, a hybrid broadcast receiver operable in accordance with embodiments herein may overwrite or otherwise alter a MMT Composition Information (MMT-CI, reference ISO/IEC DIS 23008-11) file, where certain information can refer to content elements that leverage broadband or broadcast access.

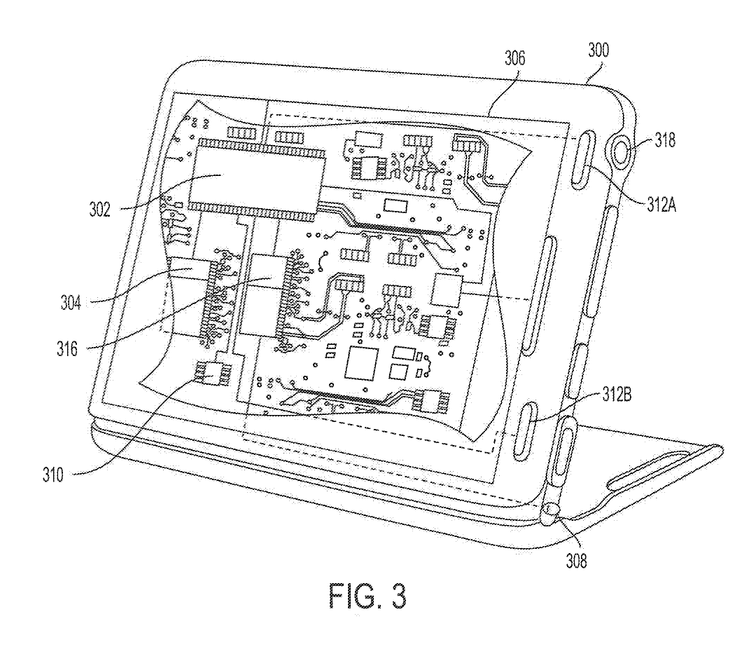

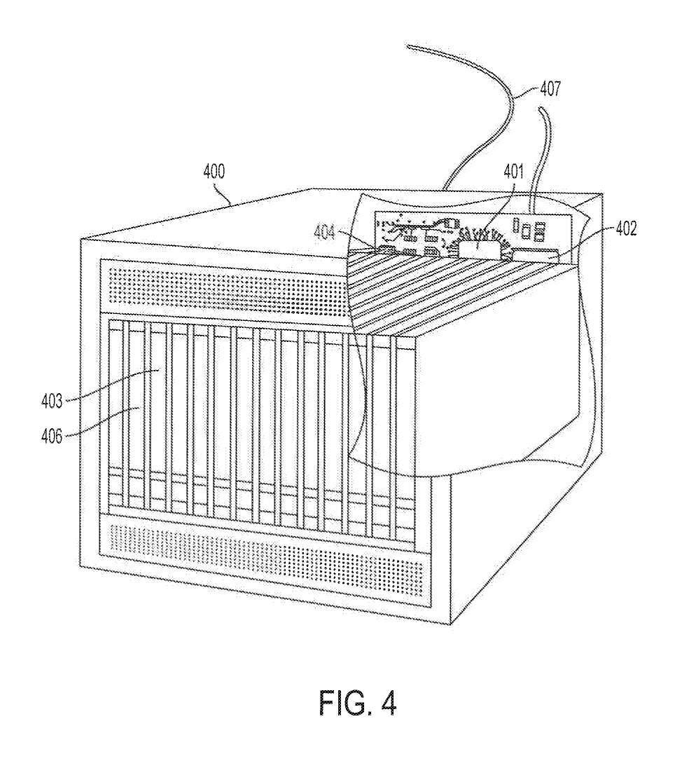

Having described hybrid broadcast receivers and operation thereof in accordance with concepts of the present disclosure, it should be understood that embodiments of a hybrid broadcast receiver may be implemented with respect to various configurations of receiver devices. FIGS. 3 and 4 illustrate exemplary configurations of receiver devices implementing a hybrid broadcast receiver of embodiments herein.

A mobile device (e.g., smart phone, tablet device, PDA, laptop computer, etc.) configuration of a receiver device as may implement a hybrid broadcast receiver in accordance with the concepts herein is illustrated in FIG. 3. Mobile device 300 may, for example, include processor 302 (e.g., operable to execute logic providing functionality of one or more of receiver 122, MPD evaluation logic 123, network selection and segment retrieval logic 124, MPD rewrite logic 125, and/or portions thereof) coupled to internal memories 304 and 310 (e.g., operable to store one or more instruction sets providing logic executed by processor 302). Internal memories 304 and 310 may be volatile or non-volatile memories, and may also be secure and/or encrypted memories, or unsecure and/or unencrypted memories, or any combination thereof. Processor 302 may also be coupled to touch screen display 306, such as a resistive-sensing touch screen, capacitive sensing touch screen infrared sensing touch screen, or the like. It should be appreciated, however, that the display of mobile device 300 need not have touch screen capability. Additionally, mobile device 300 may have one or more antennas 308 for sending and receiving electromagnetic radiation that may be connected to one or more network transceivers 316, such as a wireless data link and/or cellular (e.g., CDMA, TDMA, GSM, PCS, 3G, 4G, LTE, or any other type) transceiver, coupled to processor 302. Mobile device 300 may also include physical buttons 312A and 312B for receiving user inputs. Mobile device 300 may also include a power button 318 for turning mobile device 300 on and off.

A premise equipment (e.g., personal computer, server, set-top-box, etc.) configuration of a receiver device as may implement a hybrid broadcast receiver in accordance with the concepts herein is illustrated in FIG. 4. Premise equipment 400 may, for example, include processor 401 coupled to volatile memory 402 and a large capacity nonvolatile memory, such as disk drive 404. Premise equipment 400 may also include compact disc (CD) or DVD disc drive 406 and/or other nonvolatile memory coupled to processor 401. Premise equipment 400 may also include one or more network transceivers 403, such as a network access port, coupled to processor 401 for establishing network interface connections with communication network 407, such as may comprise the Internet, a LAN, a MAN, a WAN, the public switched telephone network (PSTN), a cellular network (e.g, CDMA, TDMA, GSM, PCS, 3G, 4G, LTE, or any other type of cellular network), etc.

Processors 302 and 401 may be any programmable microprocessor, microcomputer or multiple processor chip or chips that can be configured by software instructions (applications) to perform a variety of functions, including the functions of the various embodiments described above. For example, processors 302 and 401 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor utilized according to embodiments herein may also be implemented as a combination of computing devices (e.g., a combination of a DSP and a microprocessor, a plurality of microprocessors, one or more microprocessors in conjunction with a DSP core, or any other such configuration). In some devices, multiple processors may be provided, such as one processor dedicated to wireless communication functions and one processor dedicated to running other applications.

Typically, software applications may be stored in the internal memory 304, 310, 402, and/or 404 before they are accessed and loaded into processors 302 and 401. For example, a software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. Processors 302 and 401 of embodiments may include internal memory sufficient to store the application software instructions. In many devices the internal memory may be a volatile or nonvolatile memory, such as flash memory, or a mixture of both. For the purposes of this description, a general reference to memory refers to memory accessible by processors 302 and 401 including internal memory or removable memory plugged into the device and memory within processors 302 and 401 themselves.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for facilitating heterogeneous media services in a communication system, the method comprising:
obtaining, by a hybrid broadcast receiver of a receiver device, a computer parsable object comprising information regarding content segment availability and access, wherein the hybrid broadcast receiver comprises a receiver adapted to obtain content via both broadcast and broadband connections for a streaming client of the receiver device;
evaluating, by the hybrid broadcast receiver, the computer parsable object for one or more content segment entries indicating transport layer security is to be invoked with respect to a connection used for obtaining one or more content segments; and
overwriting, by the hybrid broadcast receiver, the one or more content segment entries preventing the transport layer security from being invoked by the streaming client.

2. The method of claim 1, wherein the one or more content segment entries indicating transport layer security comprises a Hypertext Transfer Protocol Secure (HTTPS) entry, and wherein the overwriting comprises replacing the HTTPS entry with a Hypertext Transfer Protocol (HTTP) entry without a transport layer security attribute.

3. The method of claim 2, further comprising:
intercepting, by the hybrid broadcast receiver, a content segment request made by the streaming client using the HTTP entry without a transport layer security attribute; and
obtaining, by the hybrid broadcast receiver, the content segment using the transport layer security attribute.

4. The method of claim 1, further comprising:
evaluating, by the hybrid broadcast receiver, the computer parsable object for availability of content segments via at least one broadcast connection and for availability of content segments via at least one broadband connection.

5. The method of claim 4, wherein the overwriting the one or more content segment entries comprises:
replacing at least one of a content segment pointer in the computer parsable object that directly references a segment available via the at least one broadband connection with a content segment pointer pointing to a cache of the hybrid broadcast receiver or a content segment pointer in the computer parsable object that references a segment available via the at least one broadcast connection with a content segment pointer pointing to the cache of the hybrid broadcast receiver.

6. The method of claim 4, wherein the overwriting comprises:
eliminating one or more content segment entries selected from the group consisting of content segment entries for broadband retrieval of content segments in the computer parsable object when only broadcast delivery is available, content segment entries for broadband retrieval of content segments in the computer parsable object when broadcast delivery meets user connectivity preferences, content segment entries for broadband retrieval of content segments in the computer parsable object when the hybrid broadcast receiver has already cached the one or more content segments, and content segment entries for broadcast delivery retrieval of content segments in the computer parsable object when the hybrid broadcast receiver is encountering poor reception conditions and broadband delivery of content segments is available.

7. The method of claim 1, wherein the computer parsable object comprises a Media Presentation Description (MPD) file, and wherein the streaming client comprises a Dynamic Adaptive Streaming Over Hypertext Transfer Protocol (DASH) client.

8. The method of claim 1, wherein the computer parsable object comprises a Moving Picture Experts Group (MPEG) Multimedia Transport (MMT) Composition Information (MMT-CI) file, and wherein the streaming client comprises a MMT client.

9. An apparatus configured for facilitating heterogeneous media services in a communication system, the apparatus comprising:
means for obtaining, by a hybrid broadcast receiver of a receiver device, a computer parsable object comprising information regarding content segment availability and access, wherein the hybrid broadcast receiver comprises a receiver adapted to obtain content via both broadcast and broadband connections for a streaming client of the receiver device;
means for evaluating, by the hybrid broadcast receiver, the computer parsable object for one or more content segment entries indicating transport layer security is to be invoked with respect to a connection used for obtaining one or more content segments; and
means for overwriting, by the hybrid broadcast receiver, the one or more content segment entries preventing the transport layer security from being invoked by the streaming client.

10. The apparatus of claim 9, wherein the one or more content segment entries indicating transport layer security comprises a Hypertext Transfer Protocol Secure (HTTPS) entry, and wherein the means for overwriting comprises means for replacing the HTTPS entry with a Hypertext Transfer Protocol (HTTP) entry without a transport layer security attribute.

11. The apparatus of claim 10, further comprising:
means for intercepting, by the hybrid broadcast receiver, a content segment request made by the streaming client using the HTTP entry without a transport layer security attribute; and
means for obtaining, by the hybrid broadcast receiver, the content segment using a the transport layer security attribute.

12. The apparatus of claim 9, further comprising:
means for evaluating, by the hybrid broadcast receiver, the computer parsable object for availability of content segments via at least one broadcast connection and for availability of content segments via at least one broadband connection.

13. The apparatus of claim 12, wherein the means for overwriting the one or more content segment entries comprises:
means for replacing at least one of a content segment pointer in the computer parsable object that directly references a segment available via the at least one broadband connection with a content segment pointer pointing to a cache of the hybrid broadcast receiver or a content segment pointer in the computer parsable object that references a segment available via the at least one broadcast connection with a content segment pointer pointing to the cache of the hybrid broadcast receiver.

14. The apparatus of claim 12, wherein the means for overwriting comprises:
means for eliminating one or more content segment entries selected from the group consisting of content segment entries for broadband retrieval of content segments in the computer parsable object when only broadcast delivery is available, content segment entries for broadband retrieval of content segments in the computer parsable object when broadcast delivery meets user connectivity preferences, content segment entries for broadband retrieval of content segments in the computer parsable object when the hybrid broadcast receiver has already cached the one or more content segments, and content segment entries for broadcast delivery retrieval of content segments in the computer parsable object when the hybrid broadcast receiver is encountering poor reception conditions and broadband delivery of content segments is available.

15. The apparatus of claim 9, wherein the computer parsable object comprises a Media Presentation Description (MPD) file, and wherein the streaming client comprises a Dynamic Adaptive Streaming Over Hypertext Transfer Protocol (DASH) client.

16. The apparatus of claim 9, wherein the computer parsable object comprises a Moving Picture Experts Group (MPEG) Multimedia Transport (MMT) Composition Information (MMT-CI) file, and wherein the streaming client comprises a MMT client.

17. A non-transitory computer-readable medium having program code recorded thereon for facilitating heterogeneous media services in a communication system, the program code comprising:
program code for causing a hybrid broadcast receiver of a receiver device to obtain a computer parsable object comprising information regarding content segment availability and access, wherein the hybrid broadcast receiver comprises a receiver adapted to obtain content via both broadcast and broadband connections for a streaming client of the receiver device;
program code for causing the hybrid broadcast receiver to evaluate the computer parsable object for one or more content segment entries indicating transport layer security is to be invoked with respect to a connection used for obtaining one or more content segments; and
program code for causing the hybrid broadcast receiver to overwrite the one or more content segment entries preventing the transport layer security from being invoked by the streaming client.

18. The non-transitory computer-readable medium of claim 17, wherein the one or more content segment entries indicating transport layer security comprises a Hypertext Transfer Protocol Secure (HTTPS) entry, and wherein the overwriting comprises replacing the HTTPS entry with a Hypertext Transfer Protocol (HTTP) entry without a transport layer security attribute.

19. The non-transitory computer-readable medium of claim 18, further comprising:
program code for causing the hybrid broadcast receiver to intercept a content segment request made by the streaming client using the HTTP entry without a transport layer security attribute; and
program code for causing the hybrid broadcast receiver to obtain the content segment using a the transport layer security attribute.

20. The non-transitory computer-readable medium of claim 17, further comprising:
program code for causing the hybrid broadcast receiver to evaluate the computer parsable object for availability of content segments via at least one broadcast connection and for availability of content segments via at least one broadband connection.

21. The non-transitory computer-readable medium of claim 20, wherein the program code for causing the hybrid broadcast receiver to overwrite the one or more content segment entries comprises:
program code for causing the hybrid broadcast receiver to replace at least one of a content segment pointer in the computer parsable object that directly references a segment available via the at least one broadband connection with a content segment pointer pointing to a cache of the hybrid broadcast receiver or a content segment pointer in the computer parsable object that references a segment available via the at least one broadcast connection with a content segment pointer pointing to the cache of the hybrid broadcast receiver.

22. The non-transitory computer-readable medium of claim 20, wherein the program code for causing the hybrid broadcast receiver to overwrite comprises:
program code for causing the hybrid broadcast receiver to eliminate one or more content segment entries selected from the group consisting of content segment entries for broadband retrieval of content segments in the computer parsable object when only broadcast delivery is available, content segment entries for broadband retrieval of content segments in the computer parsable object when broadcast delivery meets user connectivity preferences, content segment entries for broadband retrieval of content segments in the computer parsable object when the hybrid broadcast receiver has already cached the one or more content segments, and content segment entries for broadcast delivery retrieval of content segments in the computer parsable object when the hybrid broadcast receiver is encountering poor reception conditions and broadband delivery of content segments is available.

23. An apparatus configured for facilitating heterogeneous media services in a communication system, the apparatus comprising:
at least one processor; and
a memory coupled to the at least one processor, wherein the at least one processor is configured:
to obtain, by a hybrid broadcast receiver of a receiver device, a computer parsable object comprising information regarding content segment availability and access, wherein the hybrid broadcast receiver comprises a receiver adapted to obtain content via both broadcast and broadband connections for a streaming client of the receiver device;
to evaluate, by the hybrid broadcast receiver, the computer parsable object for one or more content segment entries indicating transport layer security is to be invoked with respect to a connection used for obtaining one or more content segments; and
to overwrite, by the hybrid broadcast receiver, the one or more content segment entries preventing the transport layer security from being invoked by the streaming client.

24. The apparatus of claim 23, wherein the one or more content segment entries indicating transport layer security comprises a Hypertext Transfer Protocol Secure (HTTPS) entry, and wherein the at least one processor configured to overwrite is configured to replace the HTTPS entry with a Hypertext Transfer Protocol (HTTP) entry without a transport layer security attribute.

25. The apparatus of claim 24, wherein the at least one processor is further configured:
to intercept, by the hybrid broadcast receiver, a content segment request made by the streaming client using the HTTP entry without a transport layer security attribute; and
to obtain, by the hybrid broadcast receiver, the content segment using a the transport layer security attribute.

26. The apparatus of claim 23, wherein the at least one processor is further configured:
to evaluate, by the hybrid broadcast receiver, the computer parsable object for availability of content segments via at least one broadcast connection and for availability of content segments via at least one broadband connection.

27. The apparatus of claim 26, wherein the at least one processor configured to overwrite the one or more content segment entries is configured:
to replace at least one of a content segment pointer in the computer parsable object that directly references a segment available via the at least one broadband connection with a content segment pointer to point to a cache of the hybrid broadcast receiver or a content segment pointer in the computer parsable object that references a segment available via the at least one broadcast connection with a content segment pointer pointing to the cache of the hybrid broadcast receiver.

28. The apparatus of claim 26, wherein the at least one processor configured to overwrite is configured:
to eliminate one or more content segment entries selected from the group consisting of content segment entries for broadband retrieval of content segments in the computer parsable object when only broadcast delivery is available, content segment entries for broadband retrieval of content segments in the computer parsable object when broadcast delivery meets user connectivity preferences, content segment entries for broadband retrieval of content segments in the computer parsable object when the hybrid broadcast receiver has already cached the one or more content segments, and content segment entries for broadcast delivery retrieval of content segments in the computer parsable object when the hybrid broadcast receiver is encountering poor reception conditions and broadband delivery of content segments is available.

29. The apparatus of claim 23, wherein the computer parsable object comprises a Media Presentation Description (MPD) file, and wherein the streaming client comprises a Dynamic Adaptive Streaming Over Hypertext Transfer Protocol (DASH) client.

30. The apparatus of claim 23, wherein the computer parsable object comprises a Moving Picture Experts Group (MPEG) Multimedia Transport (MMT) Composition Information (MMT-CI) file, and wherein the streaming client comprises a MMT client.
